(19) United States
(12) Patent Application Publication
(10) Pub. No.: US 2025/0321968 A1
(43) Pub. Date: Oct. 16, 2025

(54) DEEP SEARCH USING LARGE LANGUAGE MODELS

(71) Applicant: Microsoft Technology Licensing, LLC, Redmond, WA (US)

(72) Inventors: Andrew P. OAKLEY, Seattle, WA (US); Junyan CHEN, Kirkland, WA (US); Aparna RAJARAMAN, Woodinville, WA (US); Zhuowei LI, Redmond, WA (US); Liang-Wei CHEN, Redmond, WA (US); Rami SAYAR, Redmond, WA (US)

(73) Assignee: Microsoft Technology Licensing, LLC, Redmond, WA (US)

(21) Appl. No.: 18/634,141

(22) Filed: Apr. 12, 2024

(51) Int. Cl. G06F 16/2457; G06F 16/9532; G06F 16/9538

(52) U.S. Cl. CPC G06F 16/24578; G06F 16/9532; G06F 16/9538

(57) ABSTRACT

Systems and methods are provided for implementing deep search functionality using large language models (“LLMs”). In various examples, a computing system uses at least one LLM to generate intents based on a user query, to generate alternative queries based on a selected or identified primary intent, and to generate a relevance score for each search result that is obtained from a search utility (e.g., an Internet search engine, a file storage search utility, an email search utility, or a document storage search utility) in response to a primary query (corresponding to the primary intent) and the generated alternative queries being entered into the search utility. The search results from the search utility are sorted based on the corresponding generated relevance scores, and the sorted search results are caused to be displayed to the user as a deep search response to the user query.

### BACKGROUND

When a user requests a search (such as an Internet search), responses by search utilities typically include irrelevant or non-useful results. The more useful results may be buried within the search results or not included at all. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for implementing deep search functionality using generative artificial intelligence (“AI”) models, such as large language models (“LLMs”). By using at least one LLM, one or more intents of a user's query may be generated and expanded upon, while alternative queries may be generated based on a selected primary intent. The generated queries, which further refine the user's query are then used to query a search utility (e.g., a search engine) to generate more relevant search results. The at least one LLM or a different LLM is then used to generate a relevance score for each search result, and the search results are sorted based on their respective relevance scores prior to display to the user. In this manner, deep search functionality enables refined and improved searching to provide the user with top relevant information.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing deep search functionality using LLMs.

FIG. 2 depicts an example workflow for implementing Internet query deep search functionality using LLMs.

FIG. 3 depicts an example sequence diagram for implementing deep search functionality using LLMs.

FIG. 4 depicts block diagram illustrating an example data flow for implementing Internet query deep search functionality using LLMs.

FIGS. 5A-5J depict an example display illustrating an example user interface (“UI”) that may be used when implementing Internet query deep search functionality using LLMs.

FIG. 6 depicts an example method for implementing deep search functionality using LLMs.

FIG. 7 depicts an example method for implementing Internet query deep search functionality using LLMs.

FIG. 8 depicts a block diagram illustrating example physical components of a computing device with which aspects of the technology may be practiced.

### DETAILED DESCRIPTION OF CERTAIN EMBODIMENTS

As briefly discussed above, deep search functionalities using generative AI models, such as LLMs, provide a solution to the problem of search results returning a multitude of irrelevant or less useful results. The deep search functionalities as described herein use AI models (e.g., LLMs) to generate intents based on a user query. In some cases, the intents, which may each be referred to as a “mini-guideline,” “intent mini-guideline,” “query guideline,” or “calculated intent of a user,” may be used to generate alternative queries based on a selected or identified primary intent. The intents, in some examples, may additionally or alternatively be used to generate a relevance score for each search result that is obtained from a search utility (e.g., an Internet search engine, a file storage search utility, an email search utility, or a document storage search utility). In some instances, the relevance score may be generated in response to a primary query (corresponding to the primary intent) and the generated alternative queries being entered into the search utility. The search results from the search utility are then sorted based on the corresponding generated relevance scores, and the sorted search results are surfaced to the user as a deep search response to the user query. In this manner, refined and improved deep searching provides the user with top relevant information as compared with typical searches.

Various modifications and additions can be made to the embodiments discussed without departing from the scope of the disclosed techniques. For example, while the embodiments described above refer to particular features, the scope of the disclosed techniques also includes embodiments having different combinations of features and embodiments that do not include all of the above-described features.

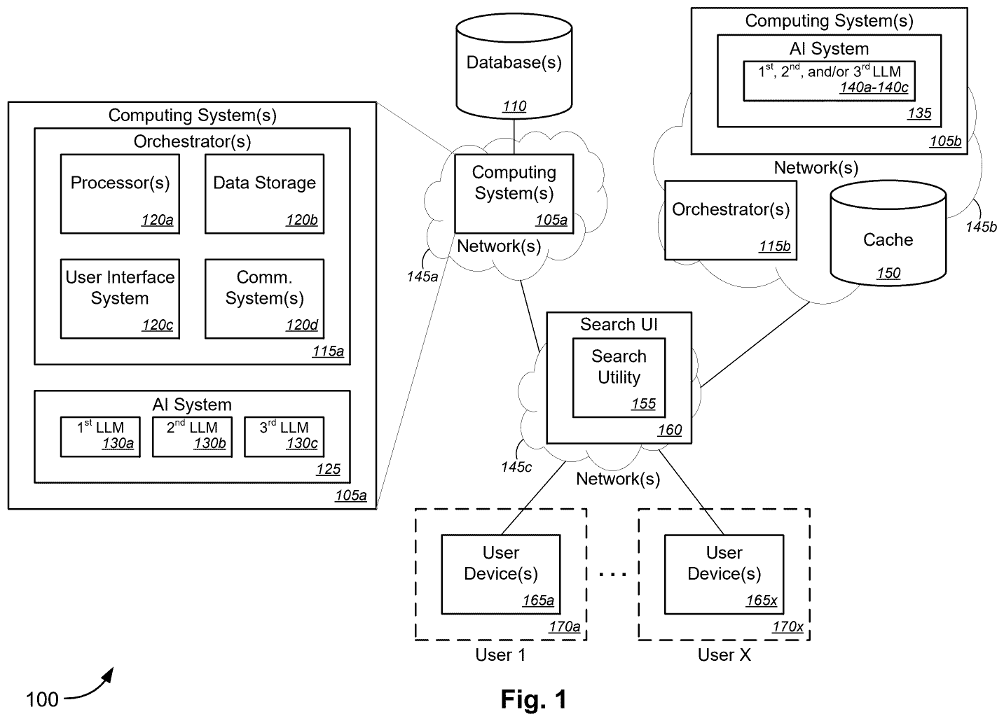

We now turn to the embodiments as illustrated by the drawings. FIGS. 1-8 illustrate some of the features of a method, system, and apparatus for implementing search functionality, and, more particularly, to methods, systems, and apparatuses for implementing deep search functionality using LLMs, as referred to above. The methods, systems, and apparatuses illustrated by FIGS. 1-8 refer to examples of different embodiments that include various components and steps, which can be considered alternatives or which can be used in conjunction with one another in the various embodiments. The description of the illustrated methods, systems, and apparatuses shown in FIGS. 1-8 is provided for purposes of illustration and should not be considered to limit the scope of the different embodiments.

FIG. 1 depicts an example system 100 for implementing deep search functionality using LLMs. System 100 includes one or more computing systems 105a and/or 105b (collectively, “computing systems 105”) and at least one database 110, which may be communicatively coupled with at least one of the one or more computing systems 105. In some examples, computing system 105a includes orchestrator 115a, which may include at least one of one or more processors 120a, a data storage device 120b, a UI system 120c, and/or one or more communications systems 120d. In some cases, computing system 105a may further include AI system 125 that each uses at least one of first through third LLMs 130a-130c (collectively, “LLMs 130”). The LLMs 130 are generative AI models that operate over a sequence of tokens, while the AI systems 125 are computing systems that utilize these generative AI models. Herein, an LLM, which is a type of language model (“LM”), may be a deep learning algorithm that can recognize, summarize, translate, predict, and/or generate text and/or other content based on knowledge gained from massive datasets. In some examples, a “language model” may refer to any model that computes the probability of P given Q, where P is a word, and Q is a number of words. As discussed above, while the examples discussed herein are described as being implemented with LLMs, other types of generative AI models may be used in some examples.

The orchestrator 115a and the AI system 125 may be disposed, located, and/or hosted on, or integrated within, a single computing system. In some examples, the orchestrator 115a and the AI system 125 may be a co-located (and physically or wirelessly linked) set of computing systems (such as shown in the expanded view of computing system 105a in FIG. 1. In other examples, the components of computing system 105a may be embodied as separate components, devices, or systems, such as depicted in FIG. 1 by orchestrator 115b and computing system 105b.

For example, AI system 135 (which is similar, if not identical, to AI system 125), which uses first, second, and/or third LLMs 140a-140c (similar to first, second, and/or third LLMs 130a-130c), may be disposed, located, and/or hosted on, or integrated within, computing system 105b. In some examples, orchestrator 115b and computing systems 105b are separate from, yet communicatively coupled with, each other. System 100 may further include cache 150. Orchestrator 115b, AI system 135, LLMs 140a-140c, computing system 105b, and cache 150 are otherwise similar, if not identical, to orchestrator 115a, AI system 125, LLMs 130a-130c, computing system 105a, and database(s) 110, respectively.

According to some embodiments, computing system 105a and database 110 may be disposed or located within network 145a, while orchestrator 115b, computing system 105b, and cache 150 may be disposed or located within network 145b, such as shown in the example of FIG. 1. In other embodiments, computing system 105a, database 110, orchestrator 115b, computing system 105b, and cache 150 may be disposed or located within the same network among networks 145a and 145b. In yet other embodiments, computing system 105a, database 110, orchestrator 115b, computing system 105b, and cache 150 may be distributed across a plurality of networks within network 145a and network 145b.

In some embodiments, system 100 includes search utility 155 via search UI 160 in network(s) 145c. In examples, system 100 further includes user devices 165a-165x (collectively, “user devices 165”) that may be associated with users 1 through X 170a-170x (collectively, “users 170”). Herein, X and x are each any suitable positive integer value. Networks 145a-145c (collectively, “network(s) 145”) may each include at least one of a distributed computing network(s), such as the Internet, a private network(s), a commercial network(s), or a cloud network(s), and/or the like. In some instances, the user devices 165 may each include one of a desktop computer, a laptop computer, a tablet computer, a smart phone, a mobile phone, or any suitable device capable of communicating with network(s) 145 or with servers or other network devices within network(s) 145. In some examples, the user devices 165 may each include any suitable device capable of communicating with at least one of the computing system 105a, the computing system 105b, and/or the orchestrator 115b, and/or the like, via a communications interface. The communications interface may include a web-based portal, an application programming interface (“API”), a server, a software application (“app”), or any other suitable communications interface (not shown), over network(s) 145. In some cases, users 170 may each include, without limitation, one of an individual, a group of individuals, or agent(s), representative(s), owner(s), and/or stakeholder(s), or the like, of any suitable entity. The entity may include, but is not limited to, a private company, a group of private companies, a public company, a group of public companies, an institution, a group of institutions, an association, a group of associations, a governmental agency, or a group of governmental agencies.

In some embodiments, the computing systems 105a or 105b may each include, without limitation, at least one of an orchestrator (e.g., orchestrator 115a or 115b), a deep search computing system, an information access device, a server, an AI system (e.g., AI systems and/or LLM-based systems 125 and/or 135), a cloud computing system, or a distributed computing system. Herein, “AI system” or “LLM-based system” may refer to a system that is configured to perform one or more artificial intelligence functions, including, but not limited to, machine learning functions, deep learning functions, neural network functions, expert system functions, and/or the like.

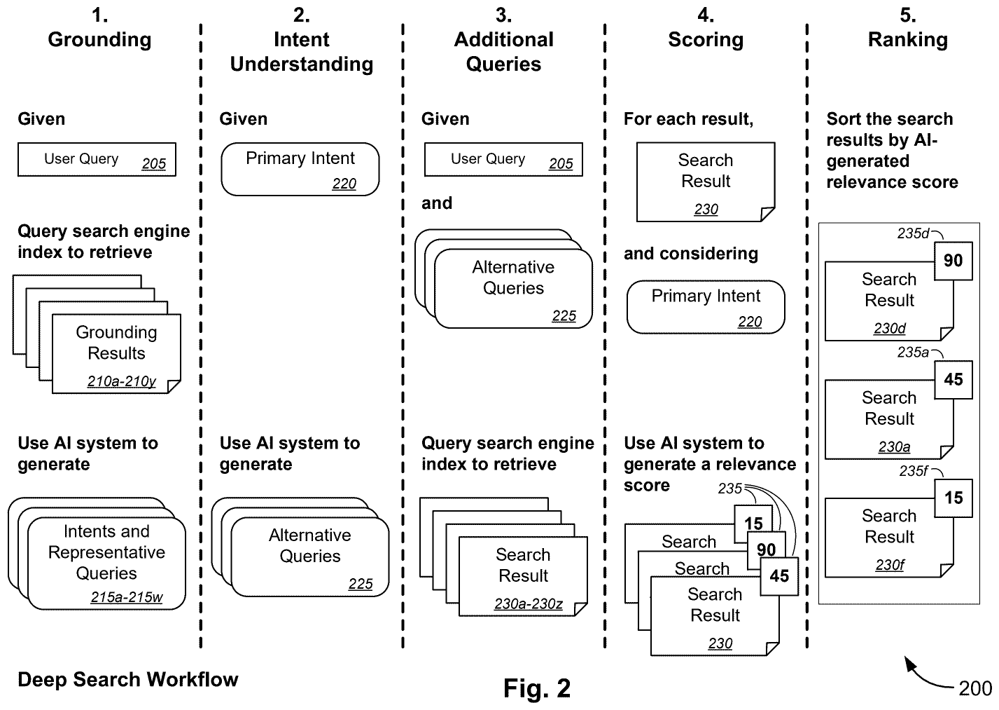

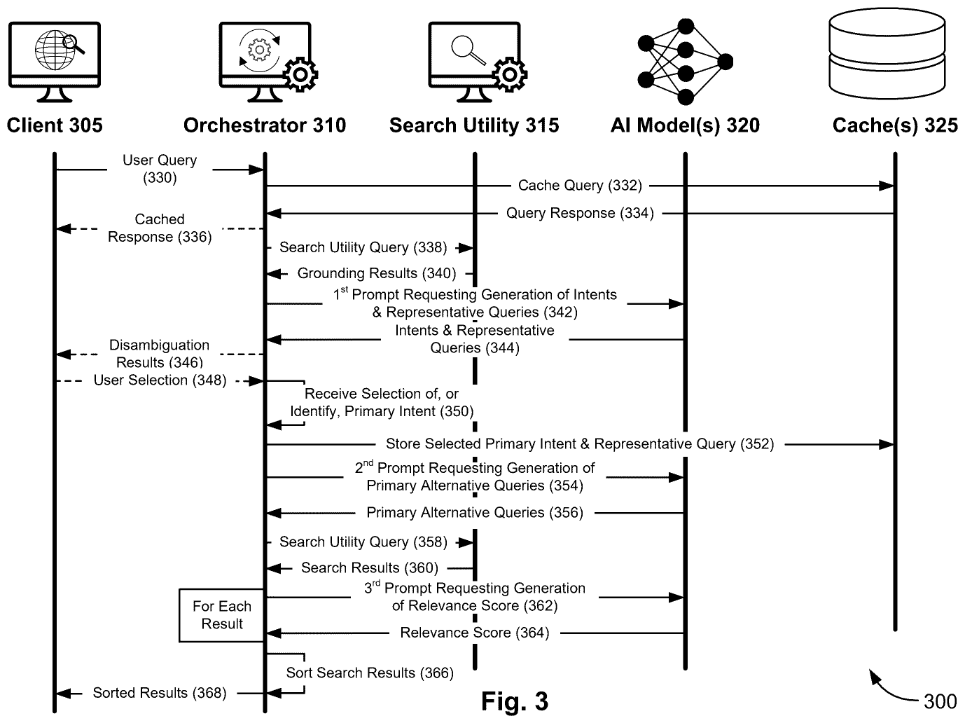

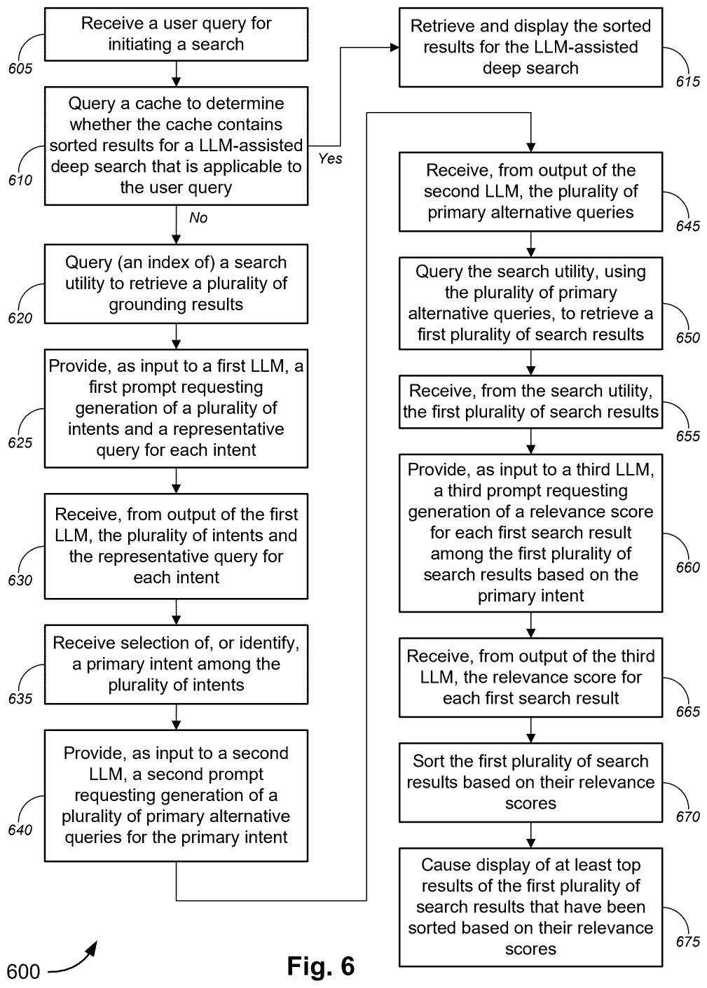

In operation, computing system 105a, computing system 105b, orchestrator 115a, and/or orchestrator 115b may perform methods for implementing deep search functionality using LLMs (as described in detail with respect to FIGS. 3 and 6) or for implementing Internet query deep search function using LLMs (as described in detail with respect to FIGS. 2, 4, 5A-5J, and 7).

FIG. 2 depicts an example workflow 200 for implementing Internet query deep search functionality using LLMs. In examples, as shown in FIG. 2, the example workflow 200 includes five stages: (1) a Grounding stage; (2) an Intent Understanding stage; (3) an Additional Queries stage; (4) a Scoring stage; and (5) a Ranking stage. In the Grounding stage, given a user query 205 from a user, a computing system (e.g., computing system 105a or 105b of FIG. 1) queries a search engine index (e.g., an index of a search engine, such as search utility 155 of FIG. 1) to retrieve a plurality of grounding results 210a-210y. The computing system uses an AI system (e.g., AI system 125 or 135 of FIG. 1) to generate a plurality of intents and corresponding plurality of queries 215a-215w, based on the user query 205 and the plurality of grounding results 210a-210y. As used in this example, “grounding results” refer to web pages or other retrieved content (and/or portions thereof) that are returned by the search engine in response to a standard web query. “Intents” (or “likely intents”), as used herein, refers to descriptions or guidelines that are calculated or generated by the AI system to focus a subsequent deep search query, as described in detail below. An “intent” corresponds to a predicted intent of the user query.

In the Intent Understanding stage, given a primary intent 220 that is selected or identified from among the plurality of intents 215a-215w, the computing system uses the AI system to generate a plurality of alternative queries 225. In the Additional Queries stage, given the user query 205 and the plurality of alternative queries 225, the computing system queries the search engine index to retrieve a plurality of search results 230a-230z. Herein, w, X or x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

In the Scoring stage, for each result (e.g., search results 230 among the one or more search results 230a-230z), and considering the primary intent 220, the computing system uses the AI system to generate a relevance score 235. In the Ranking stage, the computing system sorts the search results 230 by the AI-generated relevance scores. For example, as shown in FIG. 2, search results 230d, which has a relevance score 235d of “90,” may be ranked over search results 230a, which has a relevance score 235a of “45,” both of which may be ranked over search results 230f, which has a relevance score 235f of “15.” As used herein, “relevance score” refers to a calculated relevance to the primary intent, in some cases with a higher score being indicative of a greater relevance. In some instances, the relevance score is represented by one of a positive integer value, a range of values from a negative integer value to a positive integer value, a range of values between zero and a positive integer value (e.g., between “O” and “4”), a percentage value, or a decimal value between “0” and “1.” After the Ranking stage, the computing system causes display of the ranked or sorted search results, or at least top results thereof, to the user.

FIG. 3 depicts an example sequence diagram 300 for implementing deep search functionality using LLMs. In the example data flow 300 of FIG. 3, client 305, orchestrator 310, search utility 315, AI Model(s) 320, and cache(s) 325 may be similar, if not identical, to user devices 165a-165x, orchestrator 115a or 115b (or computing system 105a or 105b), search utility 155, LLMs 130a-130c or 140a-140c, and database 110 or cache 150, respectively, of system 100 of FIG. 1. The description of these components of system 100 of FIG. 1 are similarly applicable to the corresponding components of FIG. 3.

The data sequence begins with a user query (330) being sent from client 305 to orchestrator 310, which may be operating to perform deep search functionality. The user query (330)—which includes either a phrase, a question, or a series of key words—is used to initiate a search using search utility 315. In examples, the search utility 315 is one of an Internet search engine, a file storage search utility, an email search utility, or a document storage search utility, and the search is a corresponding one of a web search, a file search, an email search, or a document search.

In response to receiving the user query (330), orchestrator 310 sends a cache query (332) to cache(s) 325 to determine whether the cache(s) 325 contains sorted results for an LLM-assisted deep search that is applicable to the user query (330). Such cached results may exist where a deep search has been previously performed for the user query (330) or a substantially similar user query. The cache(s) 325 returns a query response (334). The query response (334) either includes the prior results (where available) or an indication that cached results are not available. For instance, in an example, the query response (334) includes sorted results for an LLM-assisted deep search that is applicable to the user query (330). In such an example, in response to receiving the query response (334) or the sorted results, the orchestrator 310 sends to client 305 cached response (336) including the sorted results from the query response (334), for display of the sorted results to the user.

In another example, the query response (334) includes an indication that the cache(s) 325 does not contain sorted results for an LLM-assisted deep search that is applicable to the user query (330). In such examples, the orchestrator 310 performs deep search tasks as described below.

The orchestrator 310 sends a search-utility query (338) to search utility 315 to retrieve a plurality of grounding results based on the user query (330). In response to receiving the grounding results (340) from the search utility 315, the orchestrator 310 provides, as input to AI Model(s) 320, a first prompt (342) requesting generation of a plurality of likely intents for the search-utility query (338) and a representative query for each intent based on the plurality of grounding results (340). The orchestrator 310 receives, from output of the AI Model(s) 320, the plurality of intents and the representative query for each intent (344).

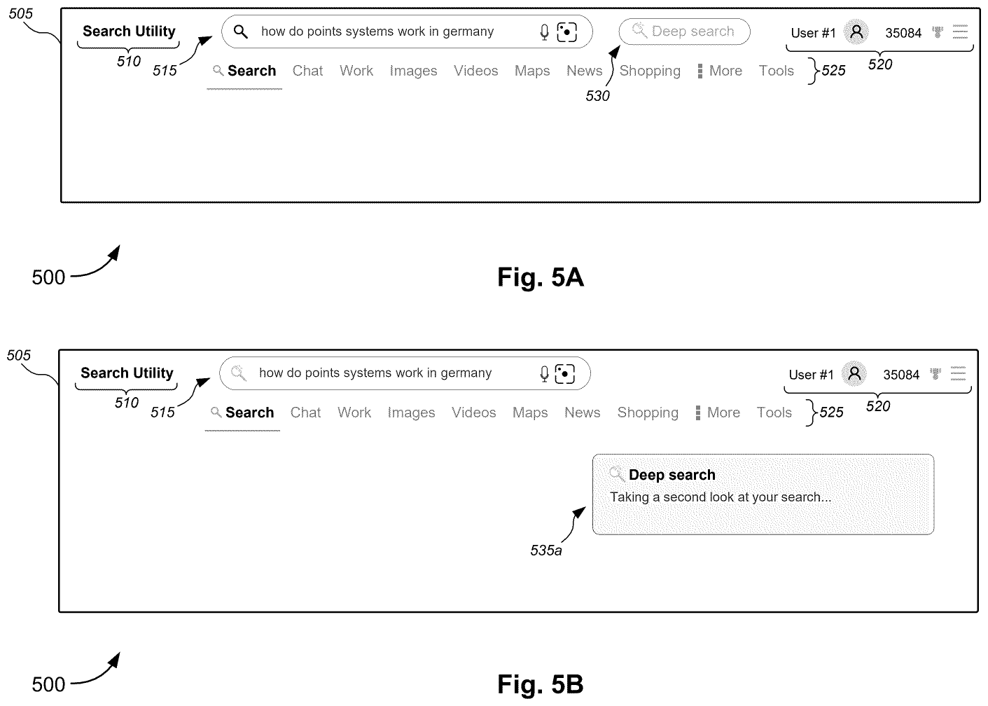

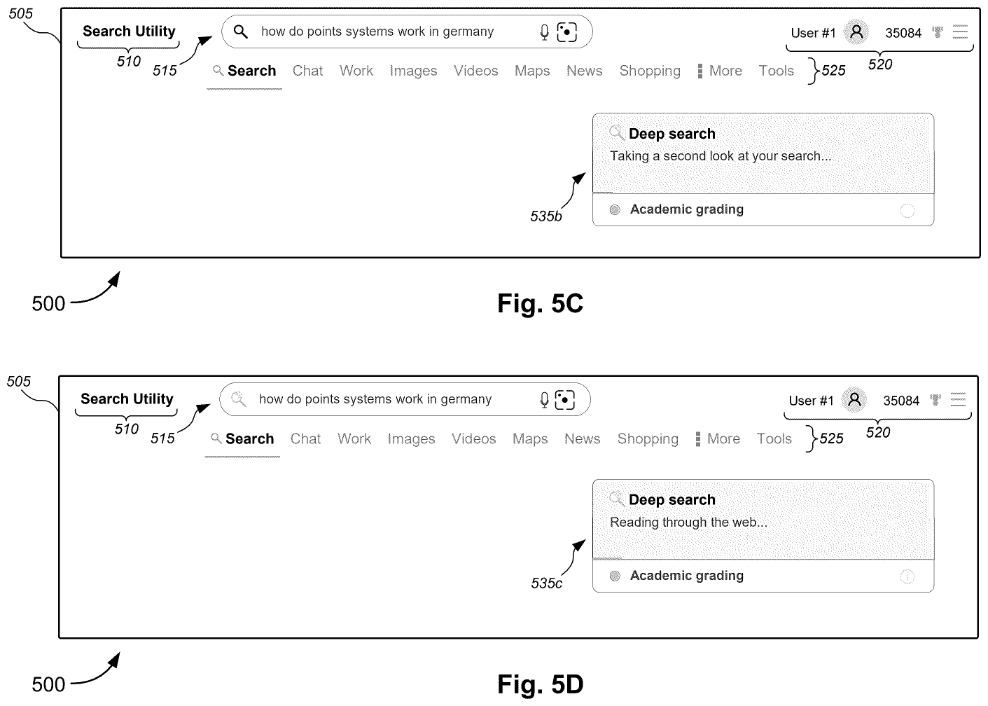

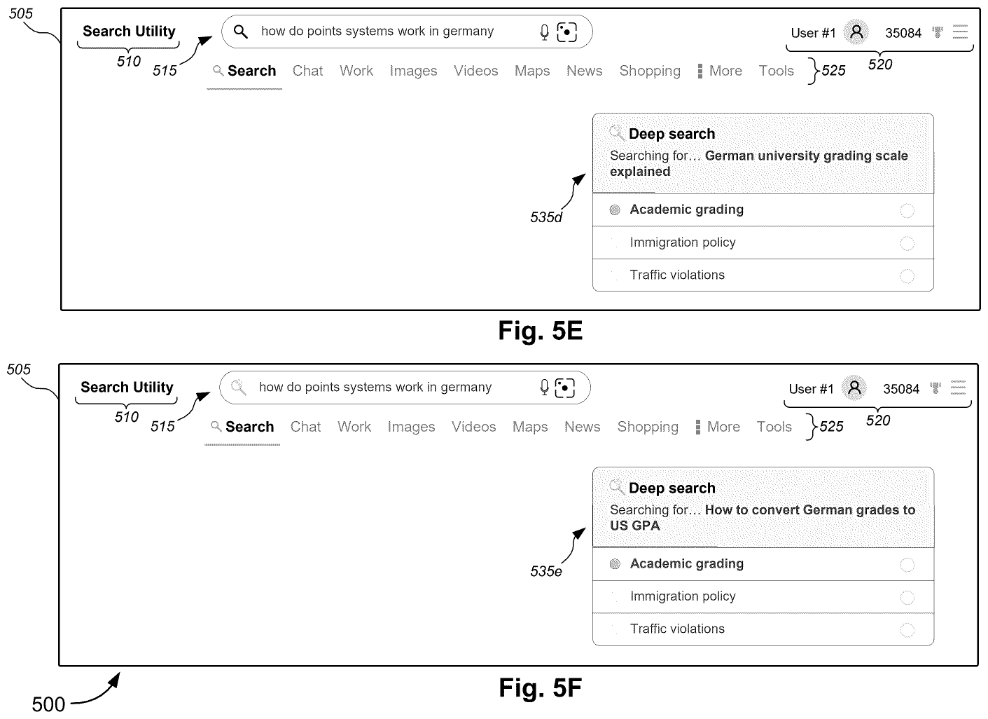

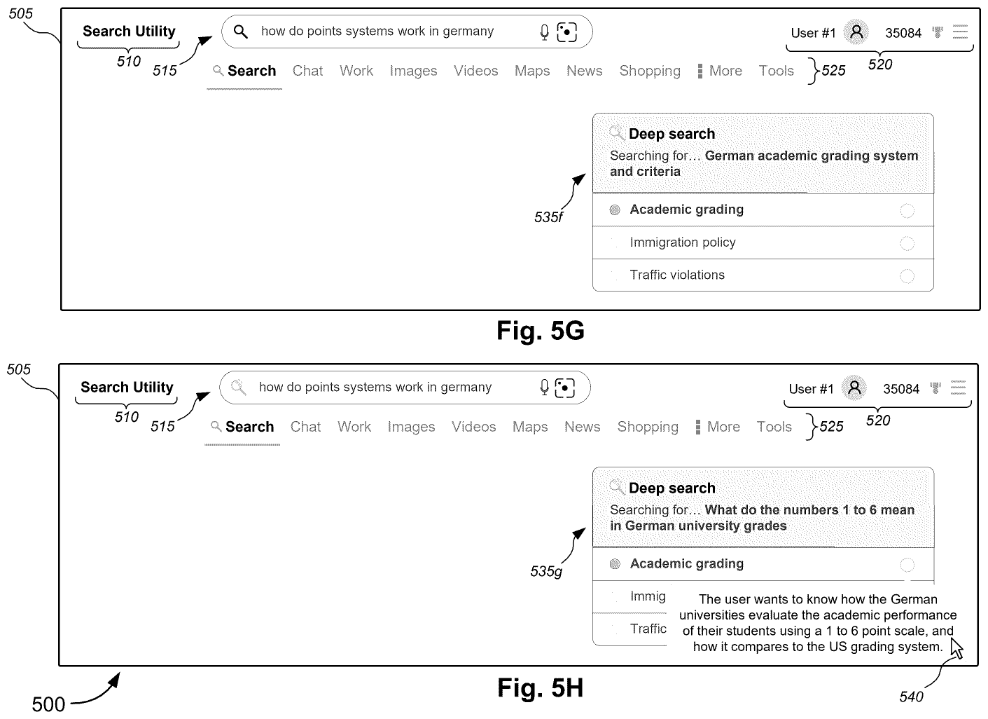

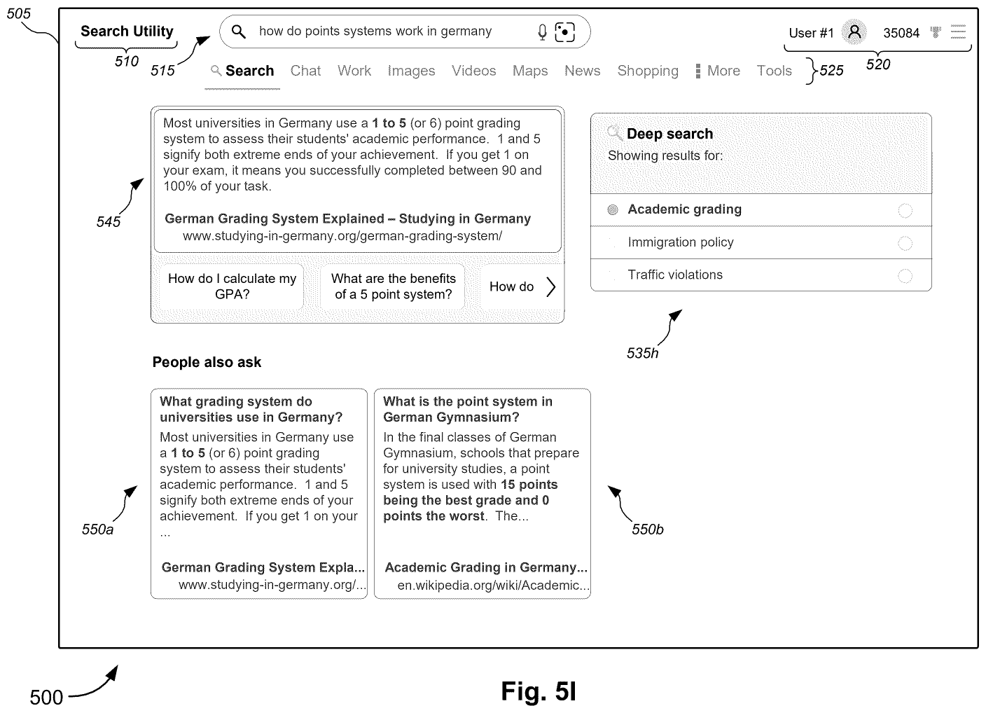

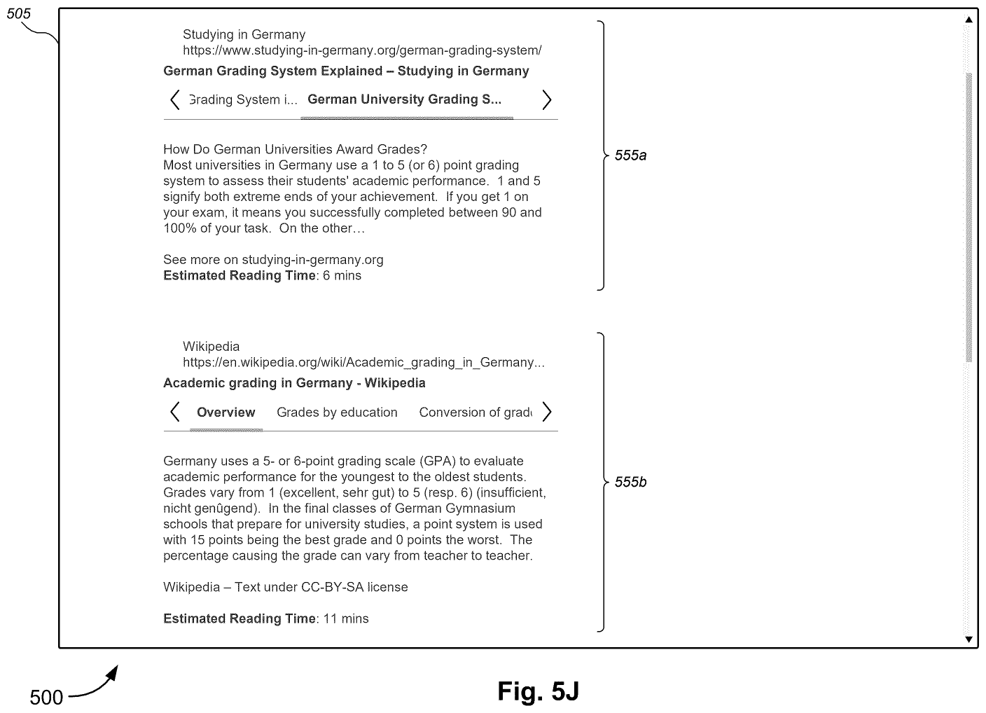

In some examples, the orchestrator 310 compiles disambiguation results (346) based on the plurality of intents, and sends the disambiguation results (346) to the client 305 for display to the user. As used herein, “disambiguation results” (or “selectable intents”) refer to a list of different intents (in some cases, potentially ambiguous intents) that are selectable by a user (such as shown, e.g., in FIGS. 5E-5I), with a default intent that is determined by the orchestrator 310 to be a likely primary intent. In response to receiving user selection (348) of one result among the disambiguation results (346), the orchestrator 310 receives selection of, or identifies, a primary intent (350) among the plurality of intents based on the user selection (348). In another example, instead of sending disambiguation results (346) to the client 305 and receiving the user selection (348), the orchestrator receives selection of, or identifies, the primary intent (350) based on a top result among the plurality of intents and the representative query for each intent (344), as received from the output of the AI Model(s) 320.

In another example, each intent among the plurality of intents has a weighted value that is based on multiple factors, the primary intent (350) is selected or identified based on the weighed value. In examples, the multiple factors include at least one of topic, type, trustworthiness, or importance. In some cases, some types of queries (e.g., where health or money is concerned), trustworthiness is important, and such queries are given more weight over degree of relevance to the user query (330). In yet another example, information about the user is collected, and the primary intent (350) is selected or identified based on the collected information. In some cases, the information is collected based at least in part on a search history of the user. In this manner, the search may be customized or personalized to the user. In examples, the orchestrator 310 stores the selected primary intent and representative query (352) in cache(s) 325.

The orchestrator 310 provides, as input to the AI Model(s) 320, a second prompt (354) requesting generation of a plurality of primary alternative queries for the primary intent, based at least in part on at least one of the primary intent or its corresponding representative query (350). The orchestrator 310 receives, from output of the AI Model(s) 320, the plurality of primary alternative queries (356). The orchestrator 310 sends a search-utility query (358) to the search utility 315 to retrieve a first plurality of search results based on the plurality of primary alternative queries (356). The orchestrator 310 receives, from the search utility, the first plurality of search results (360).

For each first search result among the first plurality of search results (360), the orchestrator 310 provides, as input to the AI Model(s) 320, a third prompt (362) requesting generation of a relevance score, and receives, from output of the AI Model(s) 320, the relevance score (364). The orchestrator 310 sorts (366) the first plurality of search results based on their relevance scores, and sends (368) at least top results of the first plurality of search results that have been sorted based on their relevance scores (366).

In an example, for a web search or Internet search, a user query (330) may be “how do points systems work in Japan.” The first prompt (342) may include instructions on how to write a query guideline that is representative of the calculated intent of the user. The first prompt (342) may further include prompt language including information regarding date, time, and/or location on or at which the user typed the query, as well as expected language, in some cases. For example, the prompt language may include dynamic data including date (e.g., “Fri Jan. 12, 2024”), time (e.g., “10:18:28 GMT-0800 (Pacific Standard Time)”), user query (e.g., “how do points systems work in Japan”), location (e.g., “XXXX______ Way, Seattle, WA 98XXX, United States”; where “X” and “_” denote redacted information that would be included in actual implementation), and language (e.g., “en” or English), while the other portions of the prompt language may be static prompt language that may be included in similar prompts. The dynamic data may be retrieved from metadata encoded with the user query, or may be obtained from data collected by the search engine. In some examples, the first prompt (342) may include grounding results from the search utility or search engine, examples of which may include one or more of the following:
2.11 Points-based preferential immigration treatment for highly . . . .
https://www.jetro.go.jp/en/invest/setting_up/section2/page11.html Learn how to apply for the points-based system for highly-skilled foreign professionals, which provides preferential treatment for immigration control and residency management. Find out the point evaluation, the categories of activities, the relaxation of requirements, and the preferential measures for different fields and situations.

What is the point system for highly skilled personnel? (Japan's green . . . .
https://www.toshihikoyamamoto.jp/what-is-the-point-system-for-highly-skilled-personnel-japans-green-card/

The Highly Skilled Foreign Professionals system evaluates applicants based on three types of activities: academic research, specialized/technical work, and management/management work. To qualify for the program, candidates must accumulate at least 70 points based on criteria such as educational background, work history, and salary level. The program offers preferential treatment for immigration control and residency management, such as multiple residence activities, a five-year period of stay, and priority processing.

In examples, the first prompt (342) may further include examples of good query intent descriptions, and in some cases, hints as well. The corresponding intents generated by the AI model(s) 320 may include one or more of the following:
Immigration points system. The user is looking for information about the points-based system for highly skilled foreign professionals, which is a government program that allows foreigners with high-level skills to stay in Japan longer and work in multiple visa categories. The user wants to know how the points are calculated, what are the benefits and requirements, and how to apply for the program.
Loyalty points system. The user is interested in the point card system, which is a popular culture in Japan where customers and consumers earn points every time they buy something from a store. The user wants to learn about the different types of point cards, how to use them, and what rewards they can get.
Traffic points system. The user is curious about the traffic violations and demerit points system in Japan, which is a system that assigns points to drivers who commit traffic offenses. The user wants to know how the points are deducted, what are the penalties and consequences, and how to avoid them.
Academic points system. The user is researching the academic grading and evaluation system in Japan, which is a system that uses points to measure the students' performance and achievements. The user wants to understand how the points are awarded, what are the standards and criteria, and how to compare them with other countries.
Sports points system. The user is a fan of sports and wants to know how the points system works in various sports leagues and competitions in Japan, such as soccer, baseball, rugby, and sumo. The user wants to see how the points are determined, what are the rules and regulations, and how to follow the standings and rankings.

In the case that two or more of the intents above are generated, the disambiguation results (346) may include a displayed list of the two or more of these intents with options to select one of them, the selection of which is received by the orchestrator as user selection (348), and used as the primary intent (350). The second prompt may include the primary intent (350) (for example, the “Immigration points system” intent guideline) as well as prompt language asking to generate alternative queries based on the primary intent (350), and the resultant primary alternative queries (356) are then used to query the search utility 315 (in this case, the search engine) to produce search results (360).

The third prompt (362) may include the original user query, the primary intent (350) (in this case, the “Immigration points system” intent guideline), and the search results (360) from the search utility 315, as well as prompt language including instructions on how to provide a score. In examples, for a score on an integer scale of 0 to 4, 0 may indicate completely irrelevant results, 1 may indicate barely relevant results, 2 may indicate somewhat relevant results, 3 may indicate mostly relevant results, and 4 may indicate ideal results. The resultant relevance scores (364) are then used to sort the search results (360) obtained from the search utility 315, and sent to the client 305 for display as sorted results (368).

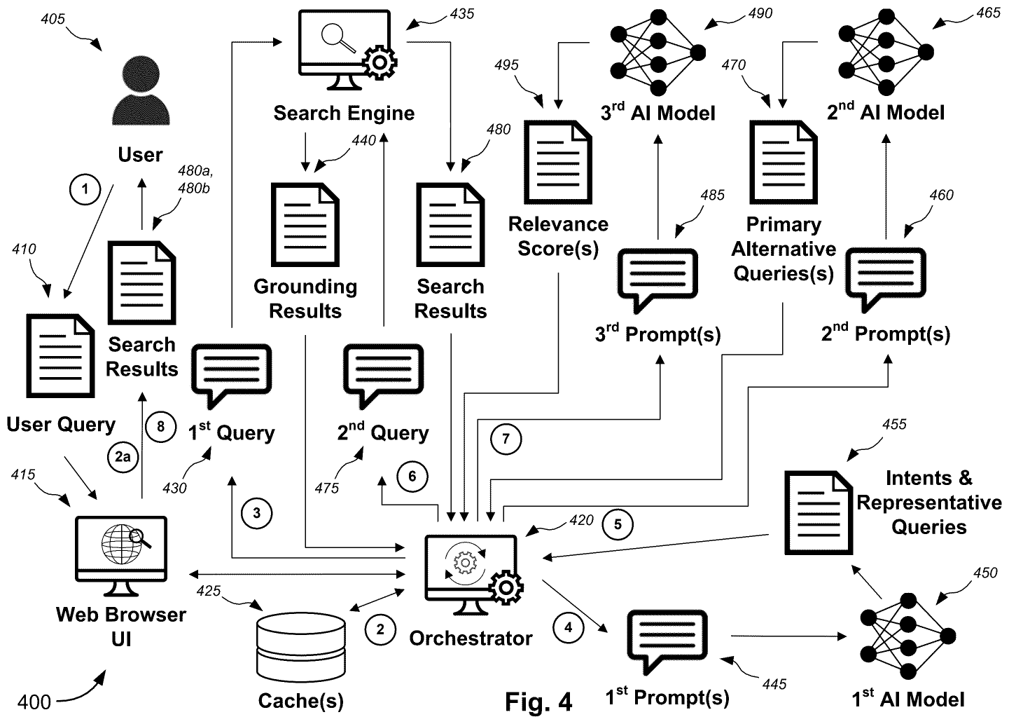

FIG. 4 depicts block diagram illustrating an example data flow 400 for implementing an Internet query deep search functionality using LLMs. In the example data flow 400 of FIG. 4, user 405, web browser UI 415, orchestrator 420, search engine 435, and AI Models 450, 465, and 480 may be similar, if not identical, to users 170a-170x, user interface system 120c or search UI 160, orchestrator 115a or 115b (or computing system 105a or 105b), search utility 155, and LLMs 130a-130c or 140a-140c, respectively, of system 100 of FIG. 1. The description of these components of system 100 of FIG. 1 are similarly applicable to the corresponding components of FIG. 4.

With reference to the example data flow 400 of FIG. 4, following the circular marker denoted, “1,” an orchestrator 420 may receive a user query 410 from a user 405 via web browser UI 415, for initiating a web search. In examples, the user query 410 may be similar to a typical query entered by a user in a UI of a search engine 435 within a web browser, the user query 410 including either a phrase, a question, or a series of key words. From the perspective of the user 405, the web search is similar to regular web searching, except for some cases in which the user 405 may select an option to initiate a deep search.

In examples, following the circular marker denoted, “2,” the orchestrator 420 queries a cache(s) 425 to determine whether the cache(s) 425 contains sorted results for an LLM-assisted deep search that is applicable to the user query 410. Based on a determination that the cache(s) 425 contains sorted results for an LLM-assisted deep search that is applicable to the user query 410, the orchestrator 420 retrieves and causes display of the sorted results 480a for the LLM-assisted deep search. In some examples, where the cache(s) 425 does contain the sorted results applicable to the user query 410, the sorted results 480a are caused to be displayed regardless of whether or not the user 405 actively selects to initiate a deep search following the circular marker denoted, “2a.” On the other hand, based on a determination that the cache(s) 425 does not contain sorted results for an LLM-assisted deep search that is applicable to the user query 410, the orchestrator 420 performs deep search tasks as described below.

For performing the deep search tasks, following the circular marker denoted, “3,” the orchestrator 420 sends a first query 430 to search engine 435 to retrieve a plurality of grounding results 440 based on the user query 410. Following the circular marker denoted, “4,” the orchestrator 420 provides, as input to a first AI model 450 (e.g., first LLM 130a or 140a of FIG. 1), a first prompt 445 requesting generation of a plurality of intents and a representative query for each intent based on the plurality of grounding results, and receives, from output of the first AI model 450, the plurality of intents and the representative query 455 for each intent. In some examples, the user query 410 is annotated with query information, including location, time, and language of the user query (e.g., as shown in the example prompt language as described above with respect to the first prompt (342) of FIG. 3). In some cases, the query information is annotated as metadata. In examples, the first prompt includes the query information (whether as metadata or as contextual information) that the first LLM may use as a basis(es) for filtering or refining resultant intents to output the plurality of intents and corresponding plurality of representative queries 455.

For instance, if the user query 410 is sent by the user 405, the location is annotated as being in the United States, and the user query 410 does not specify country, the plurality of intents and/or the corresponding plurality of representative queries 455 may include query language specifying United States, particularly where other search terms in the user query 410 may trigger search results related to other countries or regions that may be potentially confusing or irrelevant. Based on the annotated time, if there is a more recent version of the results that supersede an older or previous version, the plurality of intents and/or the corresponding plurality of representative queries 455 may be weighted toward the more recent version of the results, may be sorted to prioritize the more recent version of the results, or may be filtered to remove or hide the older or previous version. If the language is annotated as being English, the plurality of intents and/or the corresponding plurality of representative queries 455 may include query language specifying English language results, filtering out results that are primarily in a non-English language.

In some examples, the orchestrator 420 selects or identifies a primary intent among the plurality of intents. Following the circular marker denoted, “5,” the orchestrator 420 provides, as input to a second AI model 465 (e.g., second LLM 130b or 140b of FIG. 1), a second prompt 460 requesting generation of a plurality of primary alternative queries for the primary intent, based at least in part on at least one of the primary intent or its corresponding representative query 455. The orchestrator 420 receives, from output of the second AI model 465, the plurality of primary alternative queries 470. Following the circular marker denoted, “6,” the orchestrator 420 sends a second query 475 to the search engine 435 to retrieve a first plurality of web search results based on the plurality of primary alternative queries 470. The orchestrator 420 receives, from the search engine 435, the first plurality of web search results 480.

In examples, following the circular marker denoted, “7,” the orchestrator 420 provides, as input to a third AI model 490 (e.g., second LLM 130c or 140c of FIG. 1), a third prompt 485 requesting generation of a relevance score for each first web search result among the first plurality of web search results based on the primary intent. The orchestrator 420 receives, from output of the third LLM, the relevance score 495 for each first web search result 480. In examples, two or more of the first through third AI models 450, 465, and 490 are the same AI model. The orchestrator 420 sorts the first plurality of web search results 480 based on their relevance scores 495, and causes display of at least top results of the first plurality of web search results 480b that have been sorted based on their relevance scores 495, following the circular marker denoted, “8.”

FIGS. 5A-5J depict an example display illustrating an example UI 500 that may be used when implementing Internet query deep search functionality using LLMs. In example UI 500 of FIGS. 5A-5J, example UI 500 includes a web browser UI 505. Web browser UI 505 includes a header portion 510, a search field 515, a user option portion 520, a search vertical list portion 525, a deep search initiating portion 530, and a disambiguation result or selectable intent display field 535. In some examples, the web browser UI 505 is associated with a search utility. In an example, header portion 510 displays a name of the search utility. The search field 515 provides an input field for receiving a user search query or user query, which may include a text-based search query input field, an audio-based search query input field, and/or an image-based search query input field. In an example, the user option portion 520 may include a user account function, a user reward point function, and a menu function. A “vertical” or “search vertical,” as used herein, refers to a focused view of a content type that has a tab in the menu navigation. A vertical allows users to narrow down the focus results sets. After deep search has been initiated (e.g., by a user selecting or clicking a deep search button of the deep search initiating portion 530, as shown in FIG. 5A), a computing system(s) (e.g., computing system(s) 105a or 105b of FIG. 1) or an orchestrator(s) (e.g., orchestrator(s) 115a or 115b of FIG. 1) initiates and performs deep search functionality using LLMs, as described in detail with respect to FIGS. 2-4, 6, and 7.

Search results of the search utility may be filtered by selection of search verticals 525, which may include at least one of Search, Chat, Work, Images, Videos, Maps, News, and/or Shopping. In some cases, the search verticals 525 may further include More and Tools. Selection of the “Search” vertical filters the search results to display all the search results output by the search utility, with or without deep search or LLM assistance. Selection of the “Chat” vertical filters the search results to display search results from chat history. Selection of the “Work” search vertical filters the search results to display work-related files or documents among the search results (or links to the work-related files or documents). In some cases, the work-related files or documents may be encrypted or otherwise secured from access by unauthorized entities. Selection of the “Images” search vertical filters the search results to display images among the search results (or links to the images). Selection of the “Videos” search vertical filters the search results to display videos among the search results (or links to the videos). Selection of the “Maps” search vertical filters the search results to display maps among the search results (or links to the maps). Selection of the “News” search vertical filters the search results to display news articles among the search results (or links to the news articles). Selection of the “Shopping” search vertical filters the search results to display shop-based results, product-based results, or service-based results among the search results (or links to the shop-based results, product-based results, or service-based results). Selection of the “More” search vertical displays more options or other search verticals. Selection of the “Tools” search vertical displays one or more search tools (e.g., advanced search options, date time range limitations, and/or keyword search options).

As shown by the continuously updating disambiguation result or selectable intent display field 535 in FIGS. 5B-5J (as well as the continuously updating progress bar of the disambiguation result or selectable intent display field 535, as shown in FIGS. 5C-5H), deep search functionality takes time to perform. For instance, as shown in FIG. 5B, disambiguation result or selectable intent display field 535a indicates that it is taking a second look at the user's search. Turning to FIG. 5C, disambiguation result or selectable intent display field 535b shows the progress of the second look or deeper search in the form of the progress bar, with an intent (in this case, “Academic grading”) being displayed in response to the user query (in this case, “how do points systems work in germany”). Referring to FIG. 5D, disambiguation result or selectable intent display field 535c shows further progress of the second look or deeper search in the form of the progress bar, and indicates that the system is reading through results in the web. With reference to FIG. 5E, disambiguation result or selectable intent display field 535d shows yet further progress of the second look or deeper search in the form of the progress bar, while indicating that the system is searching for an alternative query generated by the LLM (in this case, “German university grading scale explained”). In examples, disambiguation result or selectable intent display field 535d further displays other potentially ambiguous results as disambiguation results or selectable intents (in this case, “Immigration policy” and “Traffic violations”). In the case that the default intent (in this case, “Academic grading”) does not align with the user's intent when entering the user query, the user may select one of the other intents displayed in the disambiguation result or selectable intent display field 535d-535h (in this case, “Immigration policy” and “Traffic violations”). In response to the user selecting on of the other intents, deep search is re-initiated, this time based on the selected intent.

As shown in FIG. 5F, disambiguation result or selectable intent display field 535e shows still further progress of the second look or deeper search in the form of the progress bar, while indicating that the system is searching for another alternative query generated by the LLM (in this case, “How to convert German grades to US GPA”). Turning to FIG. 5G, disambiguation result or selectable intent display field 535f shows continued progress of the second look or deeper search in the form of the progress bar, while indicating that the system is searching for yet another alternative query generated by the LLM (in this case, “German academic grading system and criteria”). Referring to FIG. 5H, disambiguation result or selectable intent display field 535g shows further progress of the second look or deeper search in the form of the progress bar, while indicating that the system is searching for an alternative query generated by the LLM (in this case, “What do the numbers 1 to 6 mean in German university grades”). In some examples, rolling a cursor (e.g., cursor 540) over, or clicking an information icon associated with, one of the selectable intents in the disambiguation result or selectable intent display field 535 displays details regarding the particular intent. An example of the particular intent may be “Academic grading” with corresponding details including: “The user wants to know how the German universities evaluate the academic performance of their students using a 1 to 6 point scale, and how it compares to the US grading system.”

As shown in FIG. 5I, disambiguation result or selectable intent display field 535h indicates the deep search has concluded and that the results of the deep search are being shown for the primary intent (in this case, “Academic grading”). In examples, search results determined to be most relevant to the primary intent are displayed in a first results field 545, in some cases with a link to a source of the search results. The first results field 545 may further include options for searching related information. In some examples, the deep search also displays one or more similar or related search results in corresponding one or more second results fields 550a, 550b, in some cases with a link to a source of each search result. In examples, referring to FIG. 5J, the deep search may also display one or more other similar or related search results in corresponding one or more third results fields 555a, 555b. In some cases, the one or more third results fields 555a, 555b each includes a link to a source of the search results, options to display tabbed views of the search results, and/or an estimated reading time for the user to read to the displayed search results.

FIG. 6 depicts an example method 600 for implementing deep search functionality using LLMs. The operations of method 600 may be performed by one or more computing devices, such as the devices discussed in the various systems above. In some examples, the operations of method 600 are performed by a computing system including at least one of an orchestrator (e.g., orchestrator(s) 115a-115b, 310, and/or 420 of FIGS. 1-4), a deep search computing system (e.g., computing system 105a or 105b of FIG. 1), an information access device, a server, an AI system (e.g., AI system 125 or 135 of FIG. 1), a cloud computing system, or a distributed computing system.

At operation 605, the computing system receives a user query for initiating a search. In examples, the user query is not unlike a typical query entered by a user in a UI of a search utility (e.g., search UI 160 or search utility 155, 215, or search engine 435 of FIGS. 1, 2, and 4), the user query including either a phrase, a question, or a series of key words. From the perspective of the user, the search, as initiated by the user submitting the user query, is similar to regular searching, except for some cases in which the user may select an option to initiate a deep search. In examples, the search utility is one of an Internet search engine, a file storage search utility, an email search utility, or a document storage search utility, and the search is a corresponding one of a web search, a file search, an email search, or a document search.

At operation 610, the computing system queries a cache to determine whether the cache contains sorted results for an LLM-assisted deep search that is applicable to the user query. Based on a determination that the cache contains sorted results for an LLM-assisted deep search that is applicable to the user query, the computing system retrieves and causes display of the sorted results for the LLM-assisted deep search (at operation 615). In some examples, where the cache does contain the sorted results applicable to the user query, the sorted results are caused to be displayed regardless of whether or not the user actively selects to initiate a deep search. On the other hand, based on a determination that the cache does not contain sorted results for an LLM-assisted deep search that is applicable to the user query, the computing system performs deep search tasks as described below with respect to operations 620-675.

At operation 620, the computing system queries the search utility or an index of the search utility to retrieve a plurality of grounding results based on the user query. At operation 625, the computing system provides, as input to a first LLM, a first prompt requesting generation of a plurality of intents and a representative query for each intent based on the plurality of grounding results, and receives, from output of the first LLM, the plurality of intents and the representative query for each intent (at operation 630). In some examples, the user query is annotated with query information, including location, time, and language of the user query. In some cases, the query information is annotated as metadata. In examples, the first prompt includes the query information (whether as metadata or as contextual information) that the first LLM may use as a basis(es) for filtering or refining resultant intents to output the plurality of intents and corresponding plurality of representative queries. For instance, if the user query is sent by the user, the location is annotated as being in the United States, and the user query does not specify country, the plurality of intents and/or the corresponding plurality of representative queries may include query language specifying United States, particularly where other search terms in the user query may trigger search results related to other countries or regions that may be potentially confusing or irrelevant. If the language is annotated as being English, the plurality of intents and/or the corresponding plurality of representative queries may include query language specifying English language results, filtering out results that are primarily in a non-English language.

At operation 635, the computing system receives selection of, or identifies, a primary intent among the plurality of intents. In an example, identifying the primary intent includes selecting a top result of the plurality of intents as received from (the output of) the first LLM. In another example, receiving selection of or identifying the primary intent includes receiving a user selection from among a list of disambiguation choices of the plurality of intents that is caused to be displayed to the user.

In yet another example, each intent among the plurality of intents has a weighted value that is based on multiple factors, the primary intent is selected or identified based on the weighed value. In examples, the multiple factors include at least one of topic, type, trustworthiness, or importance. In some cases, some types of queries (e.g., where health or money is concerned), trustworthiness is important, and such queries are given more weight over degree of relevance to the user query.

In still another example, information about the user is collected, and the primary intent is selected or identified based on the collected information. In some cases, the information is collected based at least in part on a search history of the user. In some instances, the computing system determines whether the (current) user query is part of the user's task at hand based on the search history. In some examples, a summary of the user information (e.g., a long-term biography of the user) may also be produced and used as part of a prompt to one or more of the second LLM or the third LLM (as described below) for performing the deep search tasks. In this manner, the search may be customized or personalized to the user.

At operation 640, the computing system provides, as input to a second LLM, a second prompt requesting generation of a plurality of primary alternative queries for the primary intent, based at least in part on at least one of the primary intent or its corresponding representative query. The computing system receives, from output of the second LLM, the plurality of primary alternative queries (at operation 645). At operation 650, the computing system queries the search utility to retrieve a first plurality of search results based on the plurality of primary alternative queries. The computing system receives, from the search utility, the first plurality of search results (at operation 655).

At operation 660, the computing system provides, as input to a third LLM, a third prompt requesting generation of a relevance score for each first search result among the first plurality of search results based on the primary intent. The computing system receives, from output of the third LLM, the relevance score for each first search result (at operation 665). In examples, two or more of the first through third LLMs are the same LLM. At operation 670, the computing system sorts the first plurality of search results based on their relevance scores, and causes display of at least top results of the first plurality of search results that have been sorted based on their relevance scores (at operation 675).

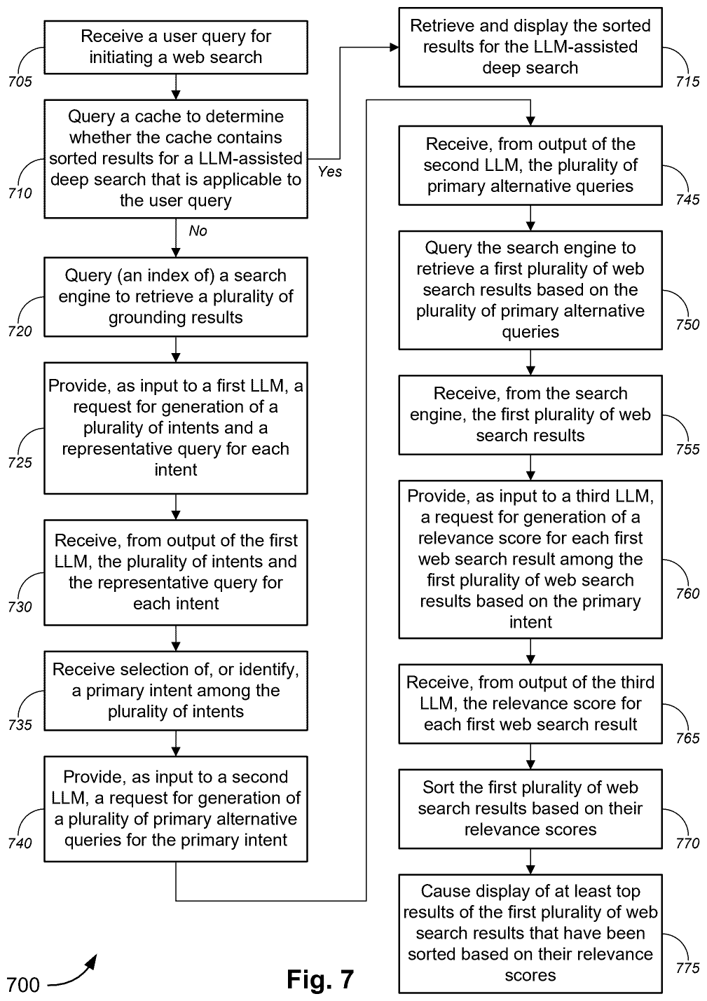

FIG. 7 depicts an example method 700 for implementing an Internet query deep search functionality using LLMs. The operations of method 700 may be performed by one or more computing devices, such as the devices discussed in the various systems above. In some examples, the operations of method 700 are performed by a computing system including at least one of an orchestrator (e.g., orchestrator(s) 115a-115b, 310, and/or 420 of FIGS. 1-4), a deep search computing system (e.g., computing system 105a or 105b of FIG. 1), an information access device, a server, an AI system (e.g., AI system 125 or 135 of FIG. 1), a cloud computing system, or a distributed computing system.

At operation 705, the computing system receives a user query for initiating a web search. As described above, the user query is not unlike a typical query entered by a user in a UI of a search engine within a web browser, the user query including either a phrase, a question, or a series of key words. From the perspective of the user, the web search is similar to regular web searching, except for some cases in which the user may select an option to initiate a deep search.

At operation 710, the computing system queries a cache to determine whether the cache contains sorted results for an LLM-assisted deep search that is applicable to the user query. Based on a determination that the cache contains sorted results for an LLM-assisted deep search that is applicable to the user query, the computing system retrieves and causes display of the sorted results for the LLM-assisted deep search (at operation 715). In some examples, where the cache does contain the sorted results applicable to the user query, the sorted results are caused to be displayed regardless of whether or not the user actively selects to initiate a deep search. On the other hand, based on a determination that the cache does not contain sorted results for an LLM-assisted deep search that is applicable to the user query, the computing system performs deep search tasks as described below with respect to operations 720-775.

At operation 720, the computing system queries the search engine or an index of the search engine to retrieve a plurality of grounding results based on the user query. At operation 725, the computing system provides, as input to a first LLM, a first prompt requesting generation of a plurality of intents and a representative query for each intent based on the plurality of grounding results, and receives, from output of the first LLM, the plurality of intents and the representative query for each intent (at operation 730). In some examples, the user query is annotated with query information, including location, time, and language of the user query. In some cases, the query information is annotated as metadata. In examples, the first prompt includes the query information (whether as metadata or as contextual information) that the first LLM may use as a basis(es) for filtering or refining resultant intents to output the plurality of intents and corresponding plurality of representative queries.

At operation 735, the computing system receives selection of, or identifies, a primary intent among the plurality of intents. In an example, identifying the primary intent includes selecting a top result of the plurality of intents as received from (the output of) the first LLM. In another example, receiving selection of or identifying the primary intent includes receiving a user selection from among a list of disambiguation choices of the plurality of intents that is caused to be displayed to the user.

In yet another example, each intent among the plurality of intents has a weighted value that is based on multiple factors, the primary intent is selected or identified based on the weighed value. In examples, the multiple factors include at least one of topic, type, trustworthiness, or importance. In some cases, some types of queries (e.g., where health or money is concerned), trustworthiness is important, and such queries are given more weight over degree of relevance to the user query.

In still another example, information about the user is collected, and the primary intent is selected or identified based on the collected information. In some cases, the information is collected based at least in part on an Internet browsing history of the user. In some instances, the computing system determines whether the (current) user query is part of the user's task at hand based on the Internet browsing history. In some examples, a summary of the user information (e.g., a long-term biography of the user) may also be produced and used as part of a prompt to one or more of the second LLM or the third LLM (as described below) for performing the deep search tasks. In this manner, the search may be customized or personalized to the user.

At operation 740, the computing system provides, as input to a second LLM, a second prompt requesting generation of a plurality of primary alternative queries for the primary intent, based at least in part on at least one of the primary intent or its corresponding representative query. The computing system receives, from output of the second LLM, the plurality of primary alternative queries (at operation 745). At operation 750, the computing system queries the search engine to retrieve a first plurality of web search results based on the plurality of primary alternative queries. The computing system receives, from the search engine, the first plurality of web search results (at operation 755).

At operation 760, the computing system provides, as input to a third LLM, a third prompt requesting generation of a relevance score for each first web search result among the first plurality of web search results based on the primary intent. The computing system receives, from output of the third LLM, the relevance score for each first web search result (at operation 765). In examples, two or more of the first through third LLMs are the same LLM. At operation 770, the computing system sorts the first plurality of web search results based on their relevance scores, and causes display of at least top results of the first plurality of web search results that have been sorted based on their relevance scores (at operation 775).

While the techniques and procedures in methods 600, 700 are depicted and/or described in a certain order for purposes of illustration, it should be appreciated that certain procedures may be reordered and/or omitted within the scope of various embodiments. Moreover, while the methods 600, 700 may be implemented by or with (and, in some cases, are described below with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, 300, 400, and 500 of FIGS. 1, 2, 3, 4, and 5A-5J, respectively (or components thereof), can operate according to the methods 600, 700 (e.g., by executing instructions embodied on a computer readable medium), the systems, examples, or embodiments 100, 200, 300, 400, and 500 of FIGS. 1, 2, 3, 4, and 5A-5J can each also operate according to other modes of operation and/or perform other suitable procedures.

As should be appreciated from the foregoing, the present technology provides multiple technical benefits and solutions to technical problems. For instance, search functionalities (such as web searching or Internet searching) raise multiple technical problems. For example, one technical problem includes search results including a multitude of irrelevant or unuseful results, particularly where a user query is short and/or ambiguous. The present technology provides for deep search functionalities using AI models. With the use of technology discussed herein, the accuracy of the search results returned is improved by reducing the number of irrelevant or less useful search results. For example, the present technology includes use of AI models to generate intents based on a user query, to generate alternative queries based on a selected or identified primary intent, and to generate a relevance score for each search result that is obtained from a search utility (e.g., an Internet search engine, a file storage search utility, an email search utility, or a document storage search utility) in response to a primary query (corresponding to the primary intent) and the generated alternative queries being entered into the search utility. The search results from the search utility are then sorted based on the corresponding generated relevance scores, and the sorted search results are caused to be displayed to the user as a deep search response to the user query. In this manner, refined and improved deep searching provides a lower error rate (e.g., more accurate results) as compared with typical searches. In some examples, an improvement of 20 points of discounted cumulative gain (“DCG”) on difficult queries may be achieved over typical search results, where DCG is a measure of ranking quality that may be used for information retrieval when presented in a normalized form (“nDCG”).

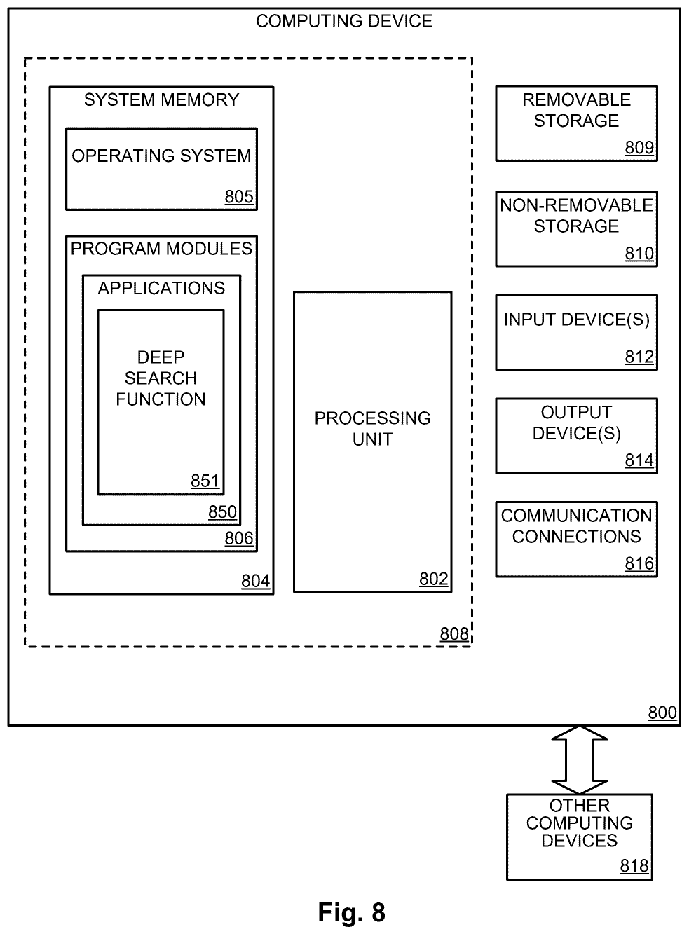

FIG. 8 depicts a block diagram illustrating physical components (i.e., hardware) of a computing device 800 with which examples of the present disclosure may be practiced. The computing device components described below may be suitable for a client device implementing the deep search using LLMs, as discussed above. In a basic configuration, the computing device 800 may include at least one processing unit 802 and a system memory 804. The processing unit(s) (e.g., processors) may be referred to as a processing system. Depending on the configuration and type of computing device, the system memory 804 may include volatile storage (e.g., random access memory), non-volatile storage (e.g., read-only memory), flash memory, or any combination of such memories. The system memory 804 may include an operating system 805 and one or more program modules 806 suitable for running software applications 850, such as a deep search function 851, to implement one or more of the systems or methods described above.

The operating system 805, for example, may be suitable for controlling the operation of the computing device 800. Furthermore, aspects of the invention may be practiced in conjunction with a graphics library, other operating systems, or any other application program and is not limited to any particular application or system. This basic configuration is illustrated in FIG. 8 by those components within a dashed line 808. The computing device 800 may have additional features or functionalities. For example, the computing device 800 may also include additional data storage devices (which may be removable and/or non-removable), such as, for example, magnetic disks, optical disks, or tape. Such additional storage is illustrated in FIG. 8 by a removable storage device(s) 809 and a non-removable storage device(s) 810.

As stated above, a number of program modules and data files may be stored in the system memory 804. While executing on the processing unit 802, the program modules 806 may perform processes including one or more of the operations of the method(s) as illustrated in FIGS. 6 and 7, or one or more operations of the system(s), apparatus(es), and/or UI(s) as described with respect to FIG. 1-5, or the like. Other program modules that may be used in accordance with examples of the present disclosure may include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 8 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 800 on the single integrated circuit (or chip). Examples of the present disclosure may also be practiced using other technologies capable of performing logical operations such as, for example, AND, OR, and NOT, including, but not limited to, mechanical, optical, fluidic, and/or quantum technologies.

The computing device 800 may also have one or more input devices 812 such as a keyboard, a mouse, a pen, a sound input device, and/or a touch input device, etc. The output device(s) 814 such as a display, speakers, and/or a printer, etc. may also be included. The aforementioned devices are examples and others may be used. The computing device 800 may include one or more communication connections 816 allowing communications with other computing devices 818. Examples of suitable communication connections 816 include, but are not limited to, radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 804, the removable storage device 809, and the non-removable storage device 810 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, and not limitation, communication media may include wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

1. A system for implementing deep search using a large language model (“LLM”), the system comprising:
a processing system; and
memory coupled to the processing system, the memory comprising computer executable instructions that, when executed by the processing system, causes the system to perform operations comprising:
receiving an initial user query;
providing, as input to a first LLM, a first prompt requesting generation of a plurality of intents for the initial user query;
receiving, from the first LLM, the plurality of intents and a representative query for each intent;
identifying a primary intent among the plurality of intents;
providing, as input to a second LLM, a second prompt requesting generation of a plurality of primary alternative queries for the primary intent based at least in part on at least one of the primary intent or its corresponding representative query;
receiving, from the second LLM, the plurality of primary alternative queries;
querying a search engine or an index of the search engine, using the plurality of primary alternative queries, to retrieve a first plurality of web search results;
receiving, from the search engine, the first plurality of web search results; and
causing display of at least top results of the first plurality of web search results.

2. The system of claim 1, wherein the operations further comprise:
querying a cache to determine whether the cache contains sorted results for an LLM-assisted deep search that is applicable to the user query;
wherein providing the first prompt, receiving the plurality of intents, identifying the primary intent, providing the second prompt, receiving the plurality of primary alternative queries, querying the search engine or the index of the search engine, receiving the first plurality of web search results, and causing display of the at least top results of the first plurality of web search results are based on a determination that the cache does not contain sorted results for an LLM-assisted deep search that is applicable to the user query.

3. The system of claim 1, wherein the operations further comprise:
querying an index of a search engine to retrieve a plurality of grounding results based on the user query;
wherein the first prompt, which is provided as input to the first LLM, includes the grounding results and requests generation of the plurality of intents and a representative query for each intent for the initial user query.

4. The system of claim 1, wherein the operations further comprise:
providing, as input to a third LLM, a third prompt requesting generation of a relevance score for each first web search result among the first plurality of web search results based on the primary intent;
receiving, from the third LLM, the relevance score for each first web search result; and
sorting the first plurality of web search results based on their relevance scores;
wherein causing display of the at least top results of the first plurality of web search results comprises causing display of at least top results of the first plurality of web search results that have been sorted based on their relevance scores.

5. The system of claim 4, wherein at least one of providing the first prompt to the first LLM, providing the second prompt to the second LLM, or providing the third prompt to the third LLM is performed using an application programming interface (“API”) call to each corresponding LLM.

6. The system of claim 1, wherein identifying the primary intent includes one of:
selecting a top result of the plurality of intents as received from the first LLM; or
receiving a user selection from among a list of disambiguation choices of the plurality of intents.

7. The system of claim 1, wherein each intent among the plurality of intents has a weighted value, wherein the primary intent is identified based on the weighted value.

8. A computer-implemented method for implementing deep search using a large language model (“LLM”), the method comprising:
receiving a user query for initiating a web search;
querying a search engine or an index of the search engine to retrieve a plurality of grounding results based on the user query;
providing, as input to a first LLM, a request for generation of a plurality of intents and a representative query for each intent based on the plurality of grounding results;
receiving, from the first LLM, the plurality of intents and the representative query for each intent;
receiving selection of a primary intent among the plurality of intents;
providing, as input to a second LLM, a request for generation of a plurality of primary alternative queries for the primary intent based at least in part on at least one of the primary intent or its corresponding representative query;
receiving, from the second LLM, the plurality of primary alternative queries;
querying the search engine, using the plurality of primary alternative queries, to retrieve a first plurality of web search results;
receiving, from the search engine, the first plurality of web search results;
providing, as input to a third LLM, a request for generation of a relevance score for each first web search result among the first plurality of web search results based on the primary intent;
receiving, from the third LLM, the relevance score for each first web search result;
sorting the first plurality of web search results based on their relevance scores; and
causing display of at least top results of the first plurality of web search results that have been sorted based on their relevance scores.

9. The computer-implemented method of claim 8, wherein two or more of the first through third LLMs are the same LLM.

10. The computer-implemented method of claim 8, wherein:
providing the request for generation of the plurality of intents and the representative query for each intent includes providing, as input to the first LLM, a first prompt requesting generation of the plurality of intents and the representative query for each intent based on the plurality of grounding results;
providing the request for generation of the plurality of primary alternative queries for the primary intent includes providing, as input to the second LLM, a second prompt requesting generation of the plurality of primary alternative queries for the primary intent based at least in part on at least one of the primary intent or its corresponding representative query; and
providing the request for generation of the relevance score for each first web search result includes providing, as input to the third LLM, a third prompt requesting generation of the relevance score for each first web search result among the first plurality of web search results based on the primary intent.

11. The computer-implemented method of claim 10, wherein at least one of providing the first prompt to the first LLM, providing the second prompt to the second LLM, or providing the third prompt to the third LLM is performed using an application programming interface (“API”) call to each corresponding LLM.

12. The computer-implemented method of claim 10, wherein the first prompt includes query information associated with the user query, the query information including location, time, and language of the user query.

13. The computer-implemented method of claim 8, further comprising:
collecting information about the user based at least in part on an Internet browsing history of the user, wherein the primary intent is further selected based on the collected information about the user.

14. The computer-implemented method of claim 8, wherein each intent among the plurality of intents has a weighted value that is based on multiple factors, wherein the plurality of intents is sorted for selection based on the weighted value.

15. The computer-implemented method of claim 8, wherein the plurality of primary alternative queries is each a deeper focused query compared with the user query.

16. A system, comprising:
a processing system; and
memory coupled to the processing system, the memory comprising computer executable instructions that, when executed by the processing system, causes the system to perform operations comprising:
querying a search utility or an index of the search utility to retrieve a plurality of grounding results based on an initial user query;
providing, as input to a first large language model (“LLM”), a first prompt requesting generation of a plurality of intents and a representative query for each intent based on the plurality of grounding results;
receiving, from the first LLM, the plurality of intents and the representative query for each intent;
receiving selection of a primary intent among the plurality of intents;
providing, as input to a second LLM, a second prompt requesting generation of a plurality of primary alternative queries for the primary intent based at least in part on at least one of the primary intent or its corresponding representative query;
receiving, from the second LLM, the plurality of primary alternative queries;
querying a search utility, using the plurality of primary alternative queries, to retrieve a first plurality of search results;
receiving, from the search utility, the first plurality of search results; and
causing display of at least top results of the first plurality of search results.

17. The system of claim 16, wherein the search utility is one of:
an Internet search engine;
a file storage search utility;
an email search utility; or
a document storage search utility.

18. The system of claim 16, wherein the operations further comprise:
receiving a user query for initiating a search; and
querying a cache to determine whether the cache contains sorted results for an LLM-assisted deep search that is applicable to the user query;
wherein querying the search utility or the index of the search utility to retrieve the plurality of grounding results, providing the first prompt, receiving the plurality of intents and the representative query for each intent, selecting the primary intent, providing the second prompt, receiving the plurality of primary alternative queries, querying the search engine to retrieve the first plurality of search results, receiving the first plurality of search results, and causing display of the at least top results of the first plurality of search results are based on a determination that the cache does not contain sorted results for an LLM-assisted deep search that is applicable to the user query.

19. The system of claim 16, wherein the operations further comprise:
providing, as input to a third LLM, a third prompt requesting generation of a relevance score for each first search result among the first plurality of search results based on the primary intent;
receiving, from the third LLM, the relevance score for each first search result; and
sorting the first plurality of search results based on their relevance scores;
wherein causing display of the at least top results of the first plurality of search results comprises causing display of at least top results of the first plurality of search results that have been sorted based on their relevance scores.

20. The system of claim 16, wherein the user query is received from an electronic device associated with a user, wherein identifying the primary intent includes one of:
selecting the primary intent based on a top result as received from the first LLM;
selecting the primary intent based on weighted values of the plurality of intents;
selecting the primary intent based on information about the user, the information about the user including information collected based on a search history of the user; or
selecting the primary intent based on user selection from among a list of disambiguation choices that are caused to be displayed to the user.
